(19) United States
(12) Patent Application Publication
(10) Pub. No.: US 2010/0170621 A1
(43) Pub. Date: Jul. 8, 2010

(54) METHOD FOR ATTACHING SMT STENCIL TO A SUBSTRATE

(76) Inventors: Hilel Shnaps, Maagan Michael (IL); Asaf Katz, Maagan Michael (IL); Tsafrir Sasson, Maagan Michael (IL)

Correspondence Address: YORAM TSIVION, P.O. BOX 1307, PARDES HANNA, 37111, IL

(21) Appl. No.: 12/663,847

(22) PCT Filed: Jun. 11, 2008
(86) PCT No.: PCT/IL08/00789

§ 371 Date: Dec. 10, 2009

Related U.S. Application Data
(60) Provisional application No. 60/943,068, filed on Jun. 11, 2007.

(51) Int. Cl. B29C 65/72; D05B 1/00; D05B 93/00; D05B 81/00

(52) U.S. Cl. 156/93; 112/475.01; 112/402; 112/270

(57) ABSTRACT

An assembly for attaching SMT stencils to a substrate, which includes: a stencil (30) having a plurality of evenly distributed holes along its periphery. The assembly further includes a frame (10) for receiving the stencil (30) and a mesh substrate, attached to the frame. A unified structure of the stencil with the mesh is formed by sewing machine, which thread through the holes of the stencil.

### TECHNICAL FIELD OF THE INVENTION

The present invention relates to SMT applications and more specifically to the attachment of SMT stencils to substrates.

### BACKGROUND OF THE INVENTION

Currently, the printing and the electronic industry uses perforated stencils for application of liquid/paste to a substrate in order to form desirable shapes of the liquid/paste on the substrate. Current practice uses the implementations of the principle of surface mount technology (SMT). In such a process the SMT stencil is assembled on a certain frame (aluminum, wood, other), suitable for working with silk screen printing machines.

There are two main methods for attaching the SMT stencil to a substrate. In one method the stencil is fixed to a working surface using pins. In the other method fixation is implemented by adhesion.

SMT stencils are used in the printing/electronic industry for the following applications: soldering of components to printed circuit boards (PCB), selective application of adhesive (for adhesion of certain components) to the substrate and SMT printing; as well as other process which use pasting of flowable medium on any substrate.

Using adhesion to attach the stencil to a frame, the edges of the SMT stencil are typically bonded to the screen frame, after which the inner portion of the screen is cut away to clear way to the printing area of the stencil. The adhesion process is simple and does not require special equipment. This method also provides for firm and uniform stretching of the SMT stencil. The SMT stencil is kept under constant load and long term strain, with no need for restretching. Notwithstanding, the process entails some disadvantages. It is slow due to long curing time of the thermoset adhesives. The current adhesive use for this application contains hazardous solvents, which requires working in ventilated environment and wearing of protective gloves and masks. In addition, the cost of the raw materials may be quite high.

### BRIEF DESCRIPTION OF THE DRAWINGS

FIG. 1 is a schematic front side isometric view of a frame in accordance with the present invention;

FIG. 2 is an isometric view of an exemplary stencil of the present invention;

FIG. 3 is an isometric view of a stencil assembled on a frame, in accordance with an embodiment of the present invention.

### DESCRIPTION OF THE PRESENT INVENTION

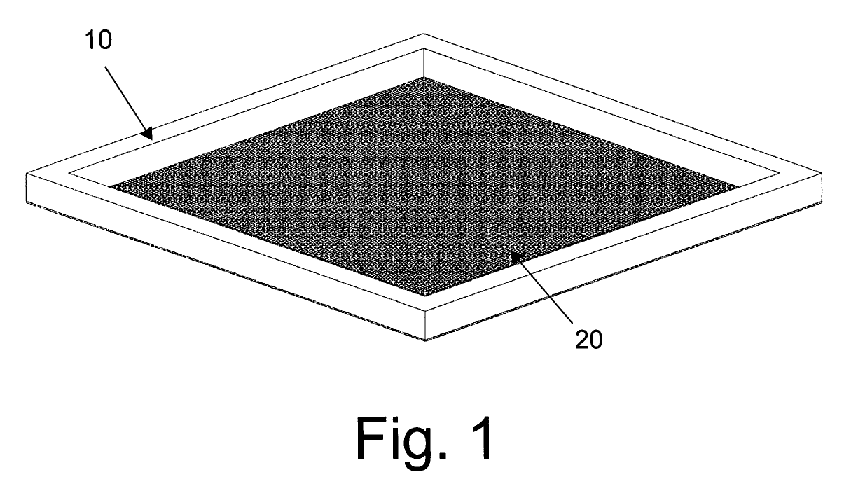

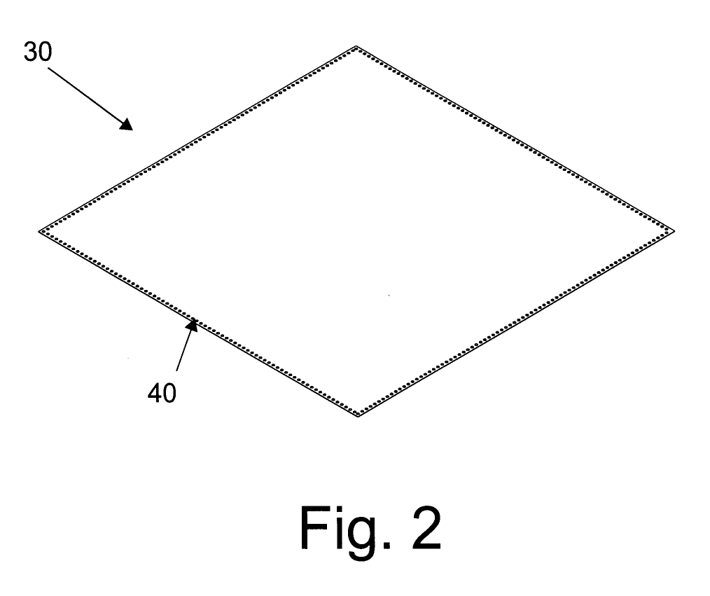

Generally, the present invention relates to the use of sewing machines to form a mechanical assembly which includes the SMT stencil and a stretched screen, used as a substrate. The positioning of the stencil on the screen is carried out before sewing. In a preferred embodiment of the invention the stencil is pre-perforated by providing through-holes in the stencil's periphery to facilitate easy and quick passage of the sewing needle through the stencil for quick sewing. The distances between the perforations holes are uniform to comply with the sewing machine's needle stroke. Referring now to FIG. 1, showing a schematic front side isometric view of a frame in accordance with the present invention. Frame 10 is a rectangularly plate, perforated at its periphery. Mesh 20 is stretched over the frame, clinging to a surface thereof. Typically, the mesh is attached to the frame by any means of adhesion. The frame is made of metal or other rigid material. This mesh acts as a receiving substrate for SMT stencil or electronic circuits. Reference is now made to FIG. 2, showing an isometric view of an exemplary stencil of the present invention. Stencil 30 is a rectangular metal sheet perforated by a plurality of evenly distributed apertures 40 along its periphery.

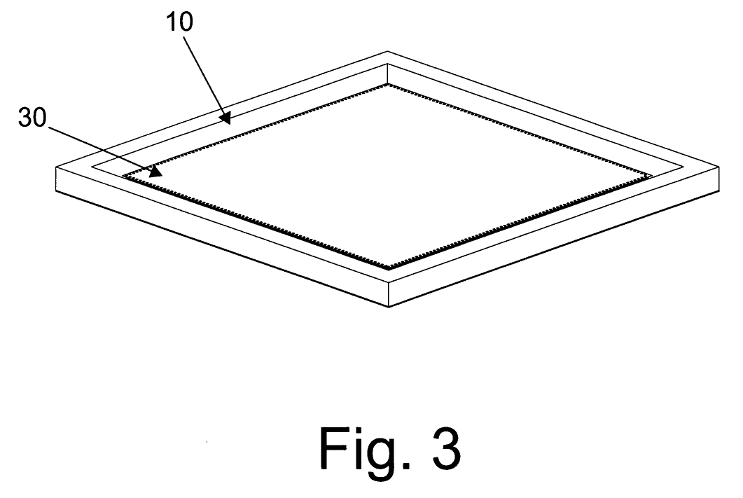

Reference is now made to FIG. 3, showing an isometric view of a stencil assembled on frame 10, in accordance with an embodiment of the present invention. Stencil 30 is laid on mesh 20 (not seen in this figure) of receiving frame 10 respectively. As aforementioned, the frame functions as a receiving element of the stencil thereby the frame is perforated to accommodate the desired form of the stencil. The method for sewing a SMT stencil is carried out as follows. First, the stencil is installed within the frame. Then, the stencil is stabilized on the mesh such as by affixing using suitable glue such as epoxy cement, but other flowable adhesion medium may be acceptable. Following, sewing machine, such as high-speed lockstitch sewing machine, “Yamata” [3450 NW 114 Avenue, Miami, Fla. 33178, USA.], is placed a on the back side of the frame, for threading through respective holes of stencil, thus unifying both, stencil and mesh substrate, forming a unified structure. Finally, the stencil is cutting of, by any means of mechanical or electrical cutting and shearing appliance, such as lasers, slitters, knifes blades, and etchers.

A sewing machine, implemented in accordance with the present invention, may require some modifications in order to render it suitable for the task. Components of the machine, such as the thread and the engine, may require replacing by high power components. Beneficially, the thread used in the sewing is made of high tensile strength materials such as Kevlar®.

### BENEFITS OF THE INVENTION

There are several advantages associated with the invention as implemented. The attachment of the stencil to the substrate is relatively quick, and there are no specific materials required. Notably, no hazardous materials are used for the attachment.

1. A method of attaching an SMT stencil to a substrate, comprising:
providing uniformly spaced apart through-holes in the periphery of the SMT stencil;
attaching said substrate to a frame;
positioning said stencil on said substrate;
sewing said stencil to said substrate using a sewing machine joining them together forming a unified structure; and
cutting said unified structure.

2. The method as in claim 1, further comprising stabilizing said stencil and said unifying of the substrate and stencil by adhesion.

3. The method as in claim 1, wherein said cutting is performed using a means selected from the group consisting of mechanical and electrical cutting appliances and shearing appliances, lasers, slitters, knifes, blades and etchers.

4. An assembly for attaching SMT stencils to a substrate, comprising:
a stencil having a plurality of evenly distributed holes along its periphery;
a frame for receiving said stencil;
a mesh substrate, attached to said frame; and
a sewing machine for threading through said holes of said stencil, forming a unified structure of said stencil with said mesh.

5. The assembly as in claim 4, wherein said mesh substrate is stretched over of said frame, clinging to a surface thereof.

6. The assembly as in claim 4, wherein said frame is perforated to accommodate said stencil.

7. The assembly as in claim 4, wherein said sewing machine is a high-speed lockstitch sewing machine.

8. The assembly as in claim 4, wherein a thread of said sewing machine is selected from the group consisting of: high tensile strength materials and aramid fiber.
